(19) United States
(12) Patent Application Publication
(10) Pub. No.: US 2011/0107216 A1
(43) Pub. Date: May 5, 2011

(54) GESTURE-BASED USER INTERFACE

(75) Inventor: NING BI, San Diego, CA (US)

(73) Assignee: QUALCOMM Incorporated, San Diego, CA (US)

(21) Appl. No.: 12/785,709

(22) Filed: May 24, 2010

Related U.S. Application Data
(60) Provisional application No. 61/257,689, filed on Nov. 3, 2009.

(51) Int. Cl. G06F 3/033; G06F 3/01

(52) U.S. Cl. 715/716; 715/863

(57) ABSTRACT

A gesture-based user interface system that includes a media-capturing device, a processor, and a display device. The media-capturing device captures media associated with a user and his/her surrounding environment. Using the captured media, the processor recognizes gestures the user uses to interact with display virtual objects displayed on the display device, without the user touching the display. A mirror image of the user and the surrounding environment is displayed in 3D on the display device with the display virtual objects in a virtual environment. The interaction between the image of the user and the display virtual objects is also displayed, in addition to an indication of the interaction such as a visual and/or an audio feedback.

This application claims the benefit of U.S. Provisional Application 61/257,689, filed on Nov. 3, 2009, the entire content of which is incorporated herein by reference.

### TECHNICAL FIELD

The disclosure relates to media devices with interactive user interfaces.

### BACKGROUND

A touch-screen user interface (UI) on an electronic device such as, for example, a computer, a media device, or a mobile communication device, presents a user interface design that generally responds to a user's input when operating the device. The touch-screen UI is used to control the device, and simplify device operation. Using a touch-screen UI, a user can operate a device with minimal training and instruction. Touch screen user interfaces have been used in a variety of handheld devices, such as cell phones, for several years. Additionally, some gaming devices use sensors in handheld controls to control a user interface.

In some situations, a device with a touch-screen UI may not be easily accessible. For example, the device may be too far away for the user to comfortably reach the screen, the screen of the device may be too big for a user to conveniently touch its entire surface, or the display surface of the device may be simply untouchable, e.g., in the case of a projector display. In such situations, the touch-screen UI may not be easily usable by touch, and may not employ remote controls.

### SUMMARY

In general, this disclosure relates to techniques for recognizing and processing gestures to enable interaction between a user and a user interface display screen, without requiring actual contact between the user and the display screen.

In one example, the disclosure is directed to a method comprising presenting an image of one or more display objects on a display screen, obtaining an image of a user, recognizing a user gesture with respect to at least one of the display objects based on the image, defining an interaction with the at least one of the display objects based on the recognized user gesture, and presenting a 3-dimensional (3D) image on the display screen that combines the image of the one or more display objects and a mirror image of the user with an indication of the interaction.

In another example, the disclosure is directed to a computer-readable medium comprising instructions for causing a programmable processor to present an image of one or more display objects on a display screen, obtain an image of a user, recognize a user gesture with respect to at least one of the display objects based on the image, define an interaction with the at least one of the display objects based on the recognized user gesture, and present a 3-dimensional (3D) image on the display screen that combines the image of the one or more display objects and a mirror image of the user with an indication of the interaction.

In another example, the disclosure is directed to a system comprising means for presenting an image of one or more display objects on a display screen, means for obtaining an image of a user, means for recognizing a user gesture with respect to at least one of the display objects based on the image, means for defining an interaction with the at least one of the display objects based on the recognized user gesture, and means for presenting a 3-dimensional (3D) image on the display screen that combines the image of the one or more display objects and a mirror image of the user with an indication of the interaction.

In another example, the disclosure is directed to a system comprising a display device that presents an image of one or more display objects on a display screen, at least one image-capturing device that obtains an image of a user, a processor that recognizes a user gesture with respect to at least one of the display objects based on the image, and a processor that defines an interaction with the at least one of the display objects based on the recognized user gesture, wherein the display device presents a 3-dimensional (3D) image on the display screen that combines the image of the one or more display objects and a mirror image of the user with an indication of the interaction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an exemplary gesture-based user interface system according to this disclosure.

FIG. 2 is a block diagram illustrating a gesture-based user interface system in accordance with this disclosure.

FIG. 3 is a flow chart illustrating operation of a gesture-based user interface system in accordance with this disclosure.

FIGS. 4A and 4B are exemplary screen shots of a gesture-based user interface system display in accordance with this disclosure.

FIGS. 5A and 5B are other exemplary screen shots of a gesture-based user interface system display in accordance with this disclosure.

### DETAILED DESCRIPTION

This disclosure describes a gesture-based user interface. In various examples, the gesture-based user interface may recognize and process gestures to enable interaction between a user and a user interface display screen. The gesture-based user interface may analyze imagery of a user, e.g., as obtained by a media-capturing device, such as a camera, to recognize particular gestures. The user interface may process the gestures to support interaction between the user and any of a variety of media presented by a user interface display screen.

A gesture-based user interface, as described in this disclosure, may be embedded in any of a variety of electrical devices such as, for example, a computing device, a mobile communication device, a media player, a video recording device, a video display system, a video telephone, a gaming system, or other devices with a display component. The user interface may present a display screen and may behave in some aspects similarly to a touch-screen user interface, without requiring the user to touch the display screen, as one would with a touch-screen user interface. In this sense, for some examples, the user interface could be compared to a non-touch, touch-screen interface in which a media-capturing device and image processing hardware process user input instead of touch-screen sensor media.

In one example, a non-touch-screen user interface system may include at least one media-capturing device, a processing unit, a memory unit, and at least one display device. The media-capturing device may be, for example, a still photo or video camera, which may be an ordinary camera, a stereo camera, a depth-aware camera, an infrared camera, an ultrasonic sensor, or any other image sensors that may be utilized to capture images and enable detecting gestures. Examples of gestures may include human hand gestures in the form of hand or finger shapes and/or movements formed by one or more hands or fingers of a user, facial movement, movement of other parts of the body, or movement of any object associated with the user, which the system may recognize via gesture detection and recognition techniques. In some examples, the location of user's hands may be determined by processing the captured images, to determine depth information. In other examples, the media-capturing device may include image- and audio-capturing devices. In some examples, the processing unit may include graphical processing capabilities or may provide functionalities of a graphical processing unit. The processing unit may be, for example, a central processing unit, dedicated processing hardware, or embedded processing hardware.

A user may use gestures to indicate a desired interaction with the user interface. The gesture-based user interface system may capture an image of the user's gestures, interpret the user's gestures, and translate the interpreted gestures into interactions with display virtual objects on the display. The display device may display, in real-time, an image of the user and his/her environment, in addition to display virtual objects with which the user may interact. The user may use gestures, such as hand shapes and/or movements to interact with the display virtual objects in a virtual environment rendered on the display, as described in more detail below. In one example, gesture recognition techniques may utilize free-form gesture recognition, which involves interpreting human gestures captured by an image-capturing device without linking the interpreted gesture with geometry information associated with the user interface. Therefore, the system may interpret any shapes and actions associated with gestures the user indicates, independent from the system design, compared to, for example, systems that can only interpret specific gestures that are based on the design of the virtual environment. For example, a system utilizing free-form gesture recognition may detect any gestures and signs indicated by the user such as, for example, hand motions indicating a number with a number of fingers the user hold up, a thumbs up or down signal, hand motions tracing a geometric shape (circular motion, a square, and the like) or any other shapes, action motions (e.g., push a button, moving a slide button), and the like. The system may also detect depth information associated with a user's hand motion, for example, if a user reaches farther in front of him/her, the system may detect the change in depth associated with the hand motion. In one example, the system may detect and recognize user gestures using free-form gesture recognition and translate the gestures into interactive actions with display virtual objects in the virtual environment.

In one example, the image of the user may be displayed in a 3-dimensional (3D) presentation on a display device that supports 3D image display. A 3D presentation conveys 3D images with a higher level of realism to a viewer, such that the viewer perceives displayed elements with a volumetric impression. Additionally, in one example, utilizing user hand gestures and depth information obtained via the captured/sensed image of the user, the user may interact with display virtual objects that appear to be placed at different distances from the user by gesturing at different distances relative to the display. For example, in the virtual environment, two display virtual objects may be displayed such that one object appears closer to the user than the other object. By gesturing, the user may be able to interact with the closer of the two objects, i.e., having an appearance of being closer to the user. Then, to interact with the farther of the two objects (i.e., having an appearance of being farther away from the user), the user may need to gesture and reach farther to reach the farther object in the virtual environment.

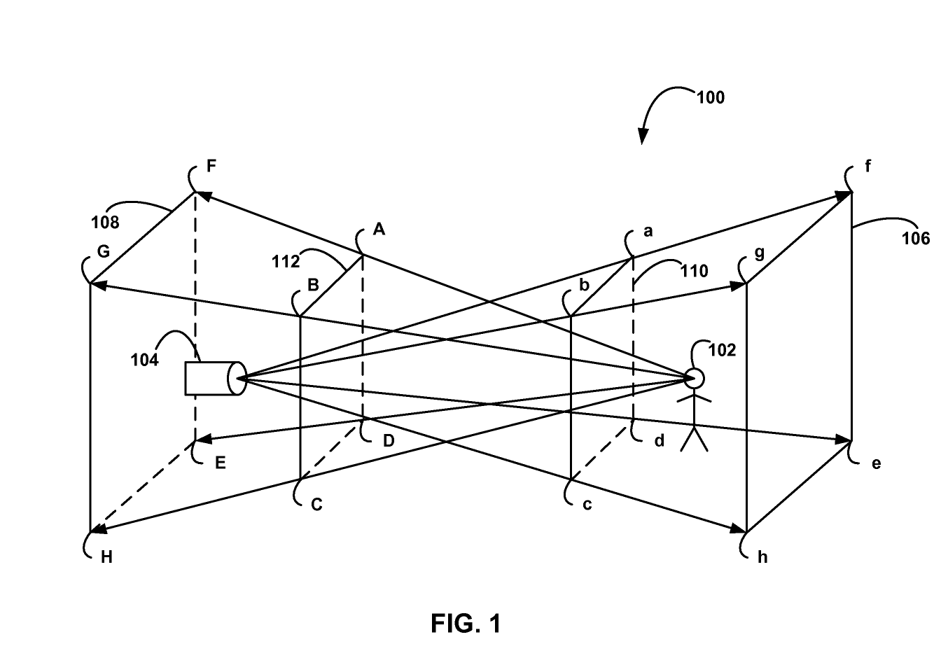

FIG. 1 illustrates an exemplary gesture-based user interface system 100 according to this disclosure. The setup of the non-touch-screen user interface system 100 may comprise a display 112, a media-capturing and processing unit 104, and a user 102 whose gestures may be captured and processed by unit 104. The system may map user 102 and the environment surrounding user 102, i.e., a real environment, to a virtual environment on a display screen. The real environment may be defined by the volume enclosed by planes 106 and 110, corresponding to the volume defined by the points abcdefgh. The virtual environment may be defined by the volume enclosed by planes 112 and 108, corresponding to the volume defined by the points ABCDEFGH, which may be a mirror image of the points abcdefgh of the real environment, respectively. The volume ABCDEFGH of the virtual environment may be a replica or mirror image of the volume abcdefgh of the real environment in addition to virtual elements with which the user may interact using gestures. In one example, the virtual environment may be a mirror image of the real environment, where the displayed image of the user and his/her surroundings may appear as a mirrored imaged of the user and his/her surroundings. The virtual environment may be displayed using a 2-dimensional (2D) or a 3D rendition. In one example, the display 112 may be capable of displaying 2D images. In this example, the camera/sensor used by the media-capturing and processing unit 104 may not provide depth information, as a result, the 3D rendition of the user and the virtual environment may be displayed in 2D space.

For illustrative purposes, the media-capturing and processing unit 104 is illustrated as one unit. In some examples, the media-capturing and processing unit 104 may be implemented in one or more units. In one example, at least a portion of the media-capturing and processing unit 104 may be positioned such that it can capture imagery of the user 102, for example, above display 112. In some examples, portions of the media-capturing and processing unit 104 may be positioned on either side of display 112, for example, two cameras may be positioned on either side of display 112 to capture imagery of user 102 from multiple angles to generate a 3D rendering of the user and the real environment. Each of the two cameras may capture an image of the user and the real environment from different perspectives. A known relationship between the positions of the two cameras may be utilized to render a 3D image of the user and the real environment. In one example, the system may comprise two cameras that may be spatially-separated such that images of user 102 may be captured from two different angles. Each of the two captured images may correspond to what the human eyes do, i.e., one image represents what the right eye sees, and another image represents what the left eye sees. Using the two images, a 3D rendering of user 102 may be generated by combining the two captured images to implement an equivalent to what occurs in the human brain, where the left eye view is combined with the right eye view to generate a 3D view.

In one example, the media-capturing and processing unit 104 may comprise, among other components, a media-capturing device such as, for example, at least one image-capturing device, e.g., a camera, a camcorder, or the like. In other examples, media-capturing and processing unit 104 may additionally comprise at least one sensor such as, for example, a motion sensor, an infrared sensor, an ultrasonic sensor, an audio sensor, or the like. In one example, an infrared sensor may generate image information based on temperature associated with objects sensed by the sensor, which may be used to determine the location and motion patterns of a user and/or user's hands. In another example, an ultrasonic sensor may generate an acoustic image based on reflections of emitted ultrasound waves off surfaces of objects such as, for example, a user and user's hands. Infrared and ultrasonic sensors may be additionally useful in an environment with poor lighting where the image of the user alone may not be sufficient to detect and recognize location and motion of user's hands.

In one example, a system may utilize an image-capturing device with an infrared or ultrasonic sensor, where the image-capturing device captures the image of the user and his/her surroundings, and the sensor provides information that the system may use to detect user's hand location and motion. In one example, the system may utilize a sensor (e.g., infrared or ultrasonic) without an image-capturing device. In such an example, the sensor may provide information that the system can user to determine a user's hand location and motion information, and to determine the shape of the user's face and/or hands to display instead of displaying the real environment with the actual image of the user.

The real environment may be within the viewing volume of the image-capturing device that captures continuous images of user 102. Based on images and signals captured by media-capturing device 104, the user and the environment surrounding the user may be mapped to a virtual environment defined by a graphics rendering of the user and his/her surrounding environment. The mapping between the real environment and the virtual environment may be a point-to-point geometric mapping as illustrated in FIG. 1. The user's hand location and motion in the real environment may also be mapped into a corresponding location and motion in the virtual environment.

In one example, the unit 104 may be capable of detecting location and depth information associated with the user and the user's hands. In one example, unit 104 may use the location and depth information to render a 3D image of the user and his/her surroundings, and to interpret and display the interaction between user 102 and display virtual objects displayed in the virtual environment. For example, in the virtual environment, two display virtual objects may be placed such that one object appears closer to the user than the other object. By gesturing, the user may be able to interact with the closer of the two objects, and to interact with the farther of the two objects, the user may need to gesture and reach farther to reach the object that appears farther in the virtual environment. Unit 104 may interpret the user's farther reach and display an interaction between the user and the display virtual object that is consistent with the distance the user reaches. In another example, the unit 104 may not be fully capable of detecting depth information or the display 112 may be a 2D display. In such an example, the unit 104 may display the rendered image of the user in 2D.

In one example, in addition to the displayed image of the user and his/her surroundings, the virtual environment may include display virtual objects with which the user may desire to interact. The display virtual objects may be, for example, graphics such as, for example, objects of a video game that the user 102 may control, menus and selections from which the user 102 may select, buttons, sliding bars, joystick, images, videos, graphics contents, and the like. User 102 may interact in the virtual environment with the display virtual objects using gestures, without touching display 112 or any other part of unit 104.

In one example, using hand gesture detection and recognition, the user interface in the virtual environment, including any display virtual objects, may be controlled by user's gestures in the real environment. For example, unit 104 may be configured to process captured imagery to detect hand motions, hand locations, hand shapes, or the like. The display virtual objects may additionally or alternatively be manipulated by the user waving one or more hands. The user may not need to hold any special devices or sensors for the user's gestures, such as hand motion and/or location, to be detected and mapped into the virtual world. Instead, the user's gestures may be identified based on captured imagery of the user. In some cases, the user's image may be displayed in real-time with the virtual environment, as discussed above, so that a user may view his or her interaction with display virtual objects. For example, user 102 may interact with the system and see an image of his/her reflection, as captured by unit 104 and displayed on display 112, which may also display some display virtual objects. User 102 may then create various gestures, e.g., by moving his/her hands around in an area where a display virtual object is displayed on display 112. In some examples, user's hand motions may be tracked by analyzing a series of captured images of user 102 to determine the interaction user 102 may be trying to have with the display virtual objects. An action associated with the gesture of user 102, such as a hand location, shape, or motion, may be applied to the corresponding display virtual object. In one example, if the display virtual object is a button, user 102 may move his/her hand as to push the button by moving the hand closer to the display, which may be recognized by detecting the image of the hand getting larger as it gets closer to the unit 104 within the region containing the button in the virtual environment. In response, the displayed virtual button is accordingly pushed on the display, and any subsequent action associated with pushing the button may result from the interaction between the user's hand in the virtual environment and the display virtual object affected by the user's action. In another example, display virtual objects may be located at different depths within the virtual environment, and user's hand gestures and location may be interpreted to interact with the display virtual objects accordingly. In this example, the user may reach farther to touch or interact with display virtual objects that appear farther in the virtual environment. Therefore, images, videos, and graphic content on the display may be manipulated by user's hand motions. In one example, the user may move his/her hand to a location corresponding to a display virtual object, e.g., a slide bar with a movable button. Processing in unit 104 may detect and interpret the location of user's hand and map it to the location corresponding to the display virtual object, then detect and interpret motions of user's hand as interacting with the display virtual object, e.g., a sliding motion of user's hand is interpreted to slide the button on the slide bar. When an image-capture device and/or sensors capture motion and location information that indicates the user has moved his/her hand from the display virtual object, e.g., by moving his/her hand suddenly to another location, processing in unit 104 interprets a termination in interaction between the user and the display virtual object (e.g., release the button of the sliding bar).

The non-touch-screen user interface system of FIG. 1 does not receive tactile sensation feedback from touching of a surface, as would be the case in a touch-screen device. In one example, the non-touch-screen user interface system may provide feedback to the user indicating successful interaction with display virtual objects displayed in the virtual environment on display 112. For example, the user interaction may involve touching, pressing, pushing, or clicking of display virtual objects in the virtual environment. In response to the user interaction, the display may indicate success of the desired interaction using visual and/or audio feedback.

In one example, the user hand motion may indicate the desire to move a display virtual object by touching it. The “touched” display virtual object may move according to the detected and recognized hand motion, and such movement may provide the user with the visual confirmation that the desired interaction was successfully completed. In another example, the used hand motion may click or press a button in the virtual environment. The button my make “clicking” sound and/or get highlighted to indicate successful clicking of the button, thus providing the user with audio and/or visual confirmation of success of the desired interaction. In other examples, the user may get feedback via a sound, a change in the display such as, for example, motions of buttons, changing colors of a sliding bar, highlighting of a joystick, or the like.

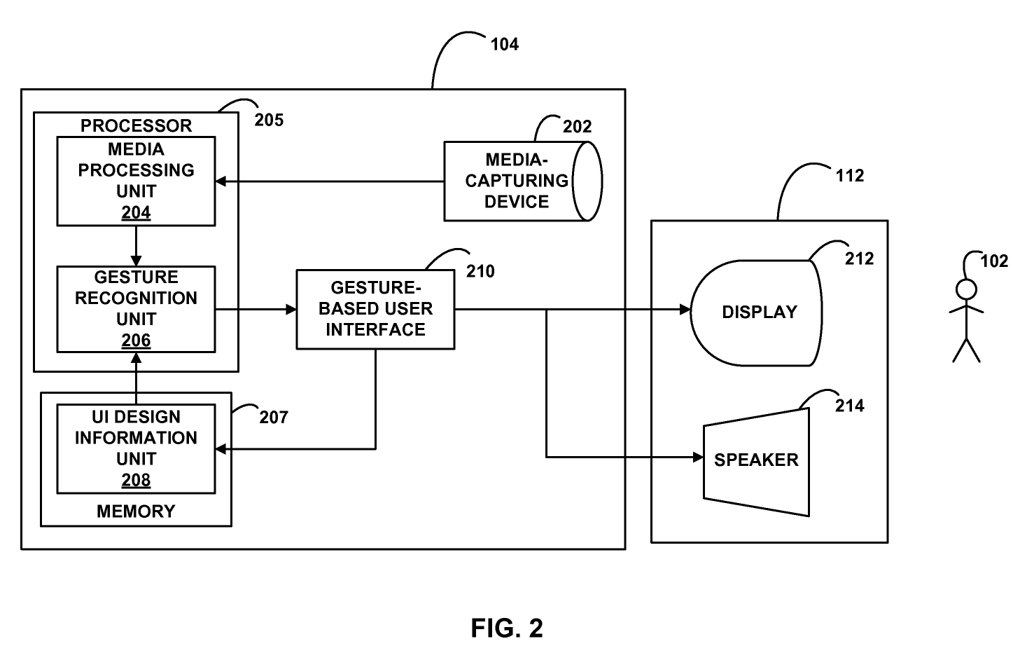

FIG. 2 is a block diagram illustrating a gesture-based user interface system architecture in accordance with this disclosure. The system may comprise a media-capturing and processing unit 104, and a media display unit 112. The unit 104 may comprise media-capturing device 202, processor 205, memory 207, and gesture-based user interface 210. The media-capturing device 202 may capture media associated with the user 102 and his/her surrounding environment or real environment. The media captured by the media-capturing device 202 may be images of the user 202 and the real environment. In some examples, the captured media may also include sounds associated with the user and the real environment. The media captured by media-capturing device 202 (e.g., image of user and his/her surrounding and/or any information from sensors associated with the media-capturing device) may be sent to media processing unit 204, where the media is processed to determine, for example, the distance and depth of the user, the motions, shapes and/or locations of the user's hands or other parts with which the user may want to interact with the user interface and other objects of the virtual environment. In one example, the media processing unit 204 may determine the information that will be used for mapping user's actions and images from the real environment into the virtual environment based on the locations of display virtual objects in the virtual environment.

Processing performed by processor 205 may utilize, in addition to the captured media, user interface design information from memory 207. The information from memory 207 may define the virtual environment and any display virtual objects in the virtual environment with which a user 102 may interact. Processor 205 may then send the processed captured media and user interface design information to user interface unit 210, which may update the user interface and send the appropriate display information to media display unit 112. The media display unit 112 may continuously display to the user an image that combines real environment objects including user 102, and display virtual objects, and interactions between the user and the display virtual objects according to the captured media and motions/gestures associated with the user. In one example, the system may continuously capture the image of the user and process any detected motions and gestures, thus providing a real-time feedback display of user's interactions with objects in the virtual environment. In one example, the images obtained by media-capturing device 202 of the 3D space of the user and the real environment may be mapped into a 3D space of the virtual environment. In this example, if media display unit 112 supports 3D display, the combined images of the user and virtual environment and objects may be displayed in 3D.

Media-capturing device 202 may comprise at least one image-capturing device such as, for example, a camera, a camcorder, or the like. In other examples, media-capturing device 202 may additionally comprise at least one sensor such as, for example, a motion sensor, an infrared sensor, an audio sensor, or the like. In one example, media-capturing device 202 may be an image-capturing device, which may capture the image of the user and his/her surroundings, i.e., the real environment. The image-capturing device may be an ordinary camera, a stereo camera, a depth-aware camera, an infrared camera, or other types of cameras. For example, an ordinary camera may capture images of the user, and the distance of the user may be determined based on his/her size, and similarly, a motion of the user's hand may be determined based on the hand's size and location in a captured image. In another example, a stereo camera may be utilized to capture a 3D image of the user. The stereo camera may be a camera that captures two or more images from different angles of the same object, or two or more cameras positioned at separate locations. In a stereo camera, the relationship between the positions of the lenses or the cameras may be known and used to render a 3D image of a captured object. In one example, two images may be captured of user 102 and his/her surrounding environment from specified angles that produce two images representing a left eye view and a right eye view. In this example, the two cameras may mimic what human eyes see, where the view of one eye is at a different angle than the view of the other eye, and what the two eyes see is combined by the human brain to produce 3D vision. In another example, a depth-aware camera may generate a depth map of the user and other objects in the real world to 3D image of the user and the real environment, and to approximate distance and movement of user's hands based on the perceived depth. In another example, an infrared camera may be used along with an image-capturing camera to determine location and movement of a user based on changes in temperature variations in infrared images. In one example, in addition to the image-capturing device, media-capturing device 202 may also be a sensor, for example, an ultrasonic sensor, an infrared sensor, or the like. The images obtained by the camera may be also used to determine spatial information such as, for example, distance and location of user's hands from the user interface. For example, media-capturing device 202 may be capable of acquiring image information that can be used to determine depth, e.g., a stereo camera or a depth-aware camera. The image information for a user's hand may represent location information in the real environment, e.g., coordinates (X_{R}, Y_{R}, Z_{R}). Media processing unit 204 may map the image information to a corresponding location in the virtual environment, e.g., coordinates (X_{V}, Y_{V}, Z_{V}). In one example, assuming that a display virtual object is at a location with the coordinates (X_{O}, Y_{O}, Z_{O}) in the virtual environment, the distance between the image of user's hand in the virtual environment and the display virtual object is SQRT ((X_{V}−X_{O})²+(Y_{V}−Y_{O})+(Z_{V}−Z_{O})²). The distance and location information may be utilized to determine what display virtual objects the user may be interacting with, when display virtual objects are located at spatially-distinct locations within the virtual environment. In such an example, one object may appear closer to the user than another object, and therefore, the user may reach farther to interact with the object that is virtually farther.

In one example, two or more image-capturing devices may be utilized to capture different perspectives of the user and the real environment to capture the 3D space in which the user 102 is located. In one example, audio sensors may additionally be utilized to determine location and depth information associated with the user. For example, an audio sensor may send out an audio signal and detect distance and/or depth of the user and other objects in the real environment based on a reflected response signal. In another example, the user may speak or make an audible sound, and based on the audio signal received by the audio sensor, additional location information of the user (e.g., user's head) may be determined utilizing an audio sensor (e.g., a microphone array or matrix). Images captured by the image-capturing device may be utilized to display the rendering of the user and the real environment. Additionally, the media-capturing device 202 may include a device or sensor that is capable of capturing and recognizing the user's gestures, and sending the captured information with the images. The gesture information may be utilized for rendering the gestures and determining a corresponding user interaction. The images of the user and the real environment along with the detected hand motions may be subsequently mapped into the displayed virtual environment, as described in more detail below. In one example, media-capturing device 202 may also include sensors capable of detecting sounds made by the user to determine location and depth information associated with the user. The media captured by media-capturing device 202 may be sent to processor 205.

Processor 205 may execute algorithms and functions capable of processing signals received from media-capturing device 202 to generate information that can be used to generate an output for media display unit 112. Processor 205 may include, among other units, a media processing unit 204 and a gesture recognition unit 206. Media processing unit 204 may process the information received from media-capturing unit 202 to generate information that can be used by gesture recognition unit 206 to determine motion/location and gesture information associated with user 102. Media processing unit 204 may also process the captured media information and translate it into a format appropriate for display on media display unit 112. For example, system 104 may not support 3D display. Therefore, media processing unit 204 may process the captured media information accordingly and differently from processing media information to be displayed in a system that supports 3D display. Additionally, media processing unit 204 may process the captured media and prepare it to be displayed so as to appear as a mirror image to user 102. The processed captured media may then be processed by gesture recognition unit 206.

Gesture recognition unit 206 may receive user interface design information 208 in addition to the information from media processing unit 204. User interface design information 208 may be information stored on memory unit 207, and may be information associated with the user interface of the system including system-specific virtual environment information such as, for example, definitions of display virtual objects. For example, in a gaming system, user interface design information 208 may include controls, characters, menus, etc., associated with the game the user is currently interacting with or playing. Gesture recognition unit 206 may process the information it receives from media processing unit 204 to determine the hand motions of the user. Gesture recognition unit 206 may then use the hand motion information with user interface design information 208 to determine the interaction between the user's hand motions and the appropriate display virtual objects.

Gesture recognition unit 206 may utilize a gesture recognition and motion detection algorithm to interpret the hand motions of user 102. In one example, gesture recognition unit 206 may utilize a free-form gesture recognition algorithm, discussed above. In free-form gesture recognition, interpreting gestures that the camera captures may be independent from the geometry information available from user interface design information 208. The geometry information may be, for example, information regarding the locations of display virtual objects and the ways/directions in which the objects may be moved, manipulated, and/or controlled by user's gestures. Initially, geometry information may be set up to default values, but as the user interacts with and moves the display virtual objects in the virtual environment, the geometry information in UI design information unit 208 may be updated to reflect the changes. For example, the geometry information of a display virtual object (e.g., a button of a sliding bar) may reflect the initial location of the display virtual object and may be expressed by the coordinates of the display virtual object, e.g., (X₁, Y₁, Z₁). In this example, if the user interacts with the display virtual object with certain gestures and moves it from its original location (e.g., shifting the button of the sliding bar), the location of the display virtual object may be updated to the new location, e.g., (X₂, Y₂, Z₂), such that if the user subsequently interacts with the display virtual object, the starting location of the object is (X₂, Y₂, Z₂).

Gesture recognition unit 206 may use other algorithms and methods of gesture recognition to find and track user's hands. In one example, a gesture recognition algorithm may track user's hands based on detected skin color of the hands. In some examples, gesture recognition algorithms may perform operations such as, for example, determining hand shapes, trajectories of hand movements, a combination of hand movement trajectories and hand shapes, and the like. Gesture recognition algorithms may utilize pattern recognition techniques, object tracking methods, and statistical models to perform operations associated with gesture recognition. In some examples, gesture recognition algorithms may utilize models similar to those associated with touch-screen user interface design, which track a user's touch on the screen and determine direction and speed of the user's touch motion, and where different types of touches are interpreted as different user interface commands (e.g., clicking a button, moving a button on a slide bar, flipping a page, and the like). Utilizing the concepts from a touch-screen user interface, in some examples, instead of the touch on the screen, a processor may implement an algorithm to utilize captured images of user's hands to recognize an associated motion, determine direction and speed, and translate hand motions to user interface commands, therefore, utilizing concepts of 2D touch-screen interaction recognition to tracking user's hand in 3D. In one example, tracking a user's hand in 3D may utilize images captured by an image-capturing device to determine the hand location in the horizontal and vertical directions, and utilize stereo camera (e.g., two image-capturing devices at different angles) to obtain a left image and a right image of the user and user's hand and calculate an offset associated with the left and right images to determine depth information or utilize a depth-aware camera to determine the depth information. As user's hand moves, processor 205 may obtain hand location information at specific intervals, and using the change of location from one interval to another, processor 205 determines a trajectory or a direction associated with the hand motion. The length of the time interval between times when images are captured and location information is determined by processor 205 may be preset, for example, to a time interval sufficient to show change in fast hand motions. Some examples of gesture recognition techniques maybe found in the following references: Wu, Y. and Huang, T., “Vision-Based Gesture Recognition: A Review,” Gesture-Based Communication in Human-Computer Interaction, Volume 1739, pages 103-115, 1999, ISBN 978-3-540-66935-7; Pavlovic, V., Sharma, R., and Huang, T., “Visual Interpretation of Hand Gestures for Human-Computer Interaction: A Review,” IEEE Transactions on Pattern Analysis and Machine Intelligence, Vol. 19, No. 7, July 1997, pages 677-695; and Mitra, S. and Acharya, T., “Gesture recognition: A Survey”, IEEE Transactions on Systems, Man, and Cybernetics, Part C: Applications and Reviews, Vol. 37, Issue 3, May 2007, pages 311-324.

Gesture recognition unit 206 may send the display information, including information regarding displaying the user, the real environment, the virtual environment, and the interaction between the user's hands and display virtual objects, to gesture-based user interface unit 210. In one example, gesture-based user interface unit 210 may include a graphical processing unit. User interface unit 210 may further process the received information to display on media display unit 112. For example, user interface unit 210 may determine the appropriate display characteristics for the processed information, and any appropriate feedback corresponding to the desired interaction between the user and the display virtual objects. In one example, the interaction between the user and display virtual objects based on the recognized hand motion and location may require some type of a visual feedback, for example, flashing, highlighting, or the like.

In other examples, the interaction between the user and display virtual objects may require an audio feedback, for example, clicking sound, sliding sound, etc. In other examples, the appropriate feedback may be a combination of visual and audio feedback. User interface unit 210 may send the display information to media display unit 112 for display. Additionally, user interface unit 210 may update user interface design information 208 according to the latest changes in the display information. For example, if a user interaction with a display virtual object indicates that the user desires the object to move within the virtual environment, user interface design information 208 may be updated such that during the next update or interaction between the user and the virtual environment, the display virtual object is in a location in accordance with the most recent interaction.

Media display unit 112 may receive the display data from the different sources after they have been collected by user interface unit 210. The data may include the real environment images and user interactions received from media processing unit 204 and gesture recognition unit 206, and the virtual environment information from UI design information unit 208. The data may be further processed by user interface unit 210 and buffered for display unit 112. Media display unit 112 may combine for display the virtual environment reflecting the image of the user and the real environment, the virtual environment with the associated display virtual objects, and the interaction between the user and any of the display virtual objects. For example, the image of user and the real environment, which media-capturing device 202 obtains and processor 205 processes may be displayed on the background of display 112. In one example, display 112 may be a stereoscopic 3D display, and the left image and right image of the real environment may be displayed in the left view and the right view of the display, respectively. Images of one or more display virtual objects may be rendered in front of, or in the foreground of display 112, based on location information obtained from UI design information unit 208. When using a stereoscopic 3D display, images of the display virtual objects may be rendered in the left view and the right view, in front of the left image and the right image of the real environment, respectively. Gesture recognition unit 206 may recognize gestures using information about the display virtual objects from UI design information unit 208 and the hand location and motion information from media processing unit 204. Gesture recognition unit 206 may recognize the hand gestures and their interaction with display virtual objects based on the location of the detected hand gestures and the location of the display virtual objects in the virtual environment. Gesture-based user interface unit 210 may use the recognized interaction information from gesture recognition unit 206 to update the UI design information unit 208. For example, when a user's hand gesture is recognized to move a display virtual object from one location to another in the virtual environment, gesture-based user interface unit 210 may update the location of the display virtual object to the new location, such that, when the user subsequently interacts with the same object, the starting location is the new updated location to which the display virtual object was last moved. Gesture-based user interface unit 210 may send a rendered image (or images where there is a left image and a right image) showing the interaction between user's hand and the display virtual objects to display device 112 for display.

In one example, media display unit 112 may update the display on frame-by-frame basis. Media display unit 112 may comprise display 212 and speaker 214. In one example, display 212 may be utilized to display all the image-based information and visual feedbacks associated with the interaction between the user and any display virtual objects. In other examples, speaker 214 may be additionally utilized to output any audio information such as, for example, audio feedback associated with the user's interaction with display virtual objects.

Display 212 may be a display device such as, for example, a computer screen, a projection of a display, or the like. Display 212 and speaker 214 may be separate devices or may be combined into one device. Speaker 214 may also comprise multiple speakers as to provide a surround sound.

In one example, media-capturing device 202 may not be equipped for or connected to devices capable of capturing location with depth information. In such an example, the images rendered on the display may be 2D renderings of the real environment and the display virtual objects. In such an example, gesture recognition may recognize gestures made by the user, and the gestures may be applied to objects in the virtual world on the display in a 2D rendering.

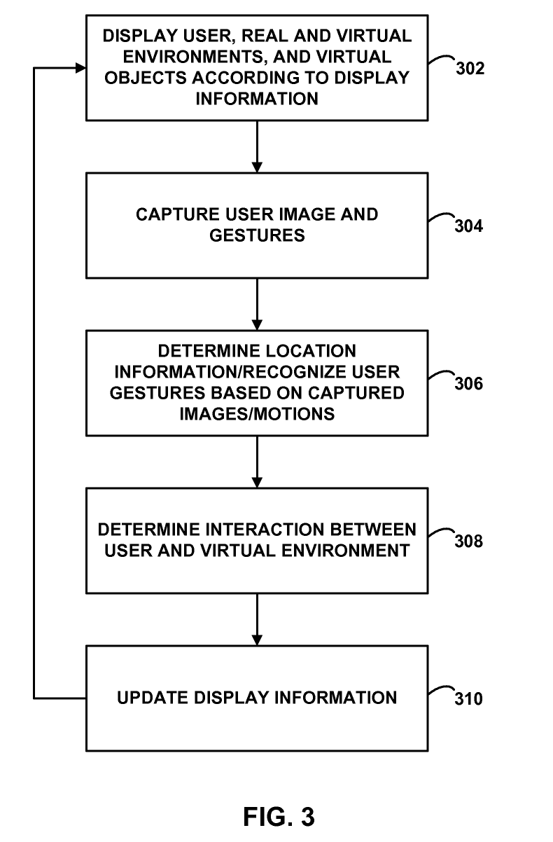

FIG. 3 is a flow chart illustrating operation of a gesture-based user interface system in accordance with this disclosure. A user may initiate interaction with a non-touch screen user interface system by standing or sitting in a location within the system's media-capturing device's field of view, e.g., where a camera may capture the image of the user and his/her motions. The system's display device may display the user and his/her surroundings, i.e., the real environment, in addition to the virtual environment and any display virtual objects according to the latest display information (302). In one example, the display information may be information regarding the different components of a virtual environment, the display virtual objects and the ways in which a user may interact with the display virtual objects. In one example, the system's display device may support 3D display, and may display the real and virtual environments in 3D. Initially, when the system is initiated, and the user had not yet interacted with display virtual objects, the display information may include the components of the virtual environment. Subsequently, after there has been interaction between the user and the virtual environment, where some display virtual objects may have moved, the display information may be updated to reflect the changes to the virtual environment and the display virtual objects according to user's interaction with them. The user and the real environment may be displayed on the display device in a mirror image rendering. The virtual environment along with display virtual objects such as, for example, buttons, slide bars, game objects, joystick, etc., may be displayed with the image of the user and the real environment.

The user may try to interact with the virtual environment by using hand motions and gestures to touch or interact with the display virtual objects displayed on the display device along with the image of the user. The media-capturing device (e.g., media-capturing device 202 of FIG. 2) may capture the user's image and gestures, e.g., hand motions and locations (304). In one example, media-capturing device 202 may capture two or more images of the user from different angles to obtain depth information and to create a 3D image for display. In one example, the two images may mimic what human eyes see, in that one image may reflect what the right eye sees, and the other image may reflect what the left eye sees. In this example, the two images may be combined to emulate the human vision process, and to produce a realistic 3D representation of the real environment mapped into the virtual environment. In another example, the images may be utilized to determine hand location and depth information, such that the distance of the reach of the user's hand may be determined. In this example, user's hand distance determination may be utilized to determine which display virtual objects the user may be interacting with, where some display virtual objects may be placed farther than other display virtual objects, and the user may reach farther to interact with the farther objects.

Processor 205 (FIG. 2) may process the captured images and gestures to determine location and depth information associated with the user and to recognize user gestures, as discussed above (306). User interface unit 210 (FIG. 2) may use the processed images to map the user and his surroundings into the virtual environment, by determining the interaction between the user and the display virtual objects in the virtual environment (308). User interface unit 210 (FIG. 2) may use the recognized gestures to determine the interaction between the user and the display virtual objects. Based on the determined interaction, the display information may be updated to reflect information regarding the user, the real environment, the virtual environment, the display virtual objects, and interactions between the user and the display virtual objects (310). User interface unit 210 may then send the updated display information to display device 112 to update the display according to the updated information (302). Display device 112 may show a movement of a display virtual object corresponding to the gestures of the user. In one example, the display may be updated at the same frame rate the image-capturing device captures images of the real environment. In another example, the display may be updated at a frame rate independent from the rate at which images of the real environment are captured. The display rate may depend, for example, on the type of display device (e.g., a fixed rate of 30 fps), or on the processing speed where the display may output frames at the rate the images are processed, or user preference based on the application (e.g., meeting, gaming, and the like). The process may continuously update the display as long as the user is interacting with the system, i.e., standing/sitting within the system's media-capturing device's field of view. In one example, the system may utilize specific hand gestures to initiate and/or terminate interaction between the user and the virtual environment. The hand gesture may be, for example, one or more specific hand gestures, or a specific sequence of hand gestures, or the like.

In one example, the user interaction with a display virtual object may be displayed with a visual feedback such as, for example, highlighting an object “touched” by the user. In other examples, the user interaction with a display virtual object may be displaying with an audio feedback such as, for example, a clicking sound when a button is “clicked” by the user.

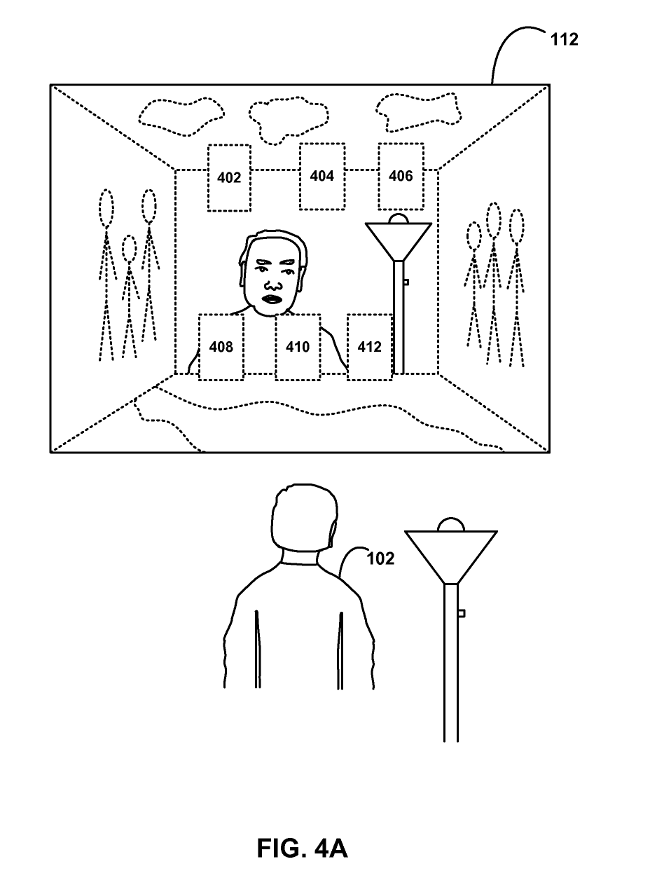

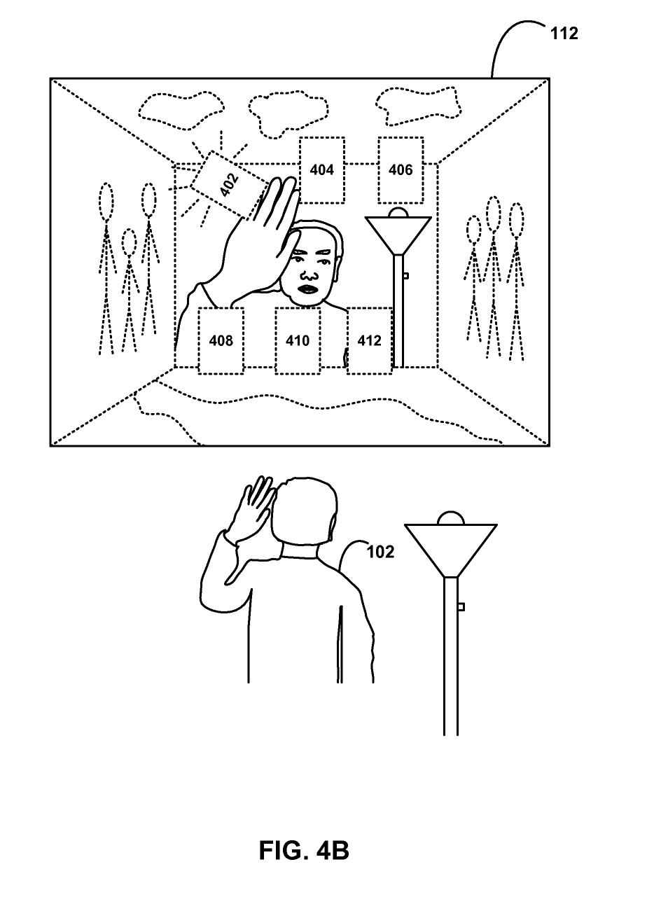

FIGS. 4 A-4B are exemplary screen shots of a gesture-based user interface system display in accordance with this disclosure. In the illustrated example, a user 102 may stand or sit in a location within the field of view of media-capturing device 202 (FIG. 2). Display 112 may show the virtual environment and display virtual objects (illustrated with dotted lines). Display virtual objects 402, 404, 406, 408, 410, and 412 may be objects with which the user may interact using gestures. When the system is first initiated, the user may have not yet interacted with the virtual environment or any display virtual objects. The image of the user and the real environment surrounding the user within the viewing field of media-capturing device 202 may be displayed on display 112, as illustrated in FIG. 4A. The image of the user and the real environment may be a mirror image of the user.

The user may then start interacting with the virtual environment by gesturing with his/her hands to touch one of the display virtual objects, as illustrated in FIG. 4B. As the user gestures, using his/her left hand in this example, media-capturing device 202 may capture the user's image and gestures. Processor 205 may process the captured images, and send updated information to user interface unit 210, which may process the data from processor 205 with the display data stored in UI design information 208. The display data is then buffered to display device 112 for display. Display device 112 then displays the image of the user and the recognized hand gesture is translated to an interaction with the appropriate display virtual object, in this example, object 402. As illustrated, the gesture of the user's hand is a tapping gesture and causes display virtual object 402 to move accordingly. In other examples, the interaction between the user and the display virtual object may depend on the gesture and/or the object. For example, if the display virtual object is a button, the user's hand gesture touching the button may be interpreted to cause the button to be pushed. In another example, the display virtual object may be a sliding bar, and the user's interaction may be to slide the bar.

When the user interacts with a display virtual object, the display may change the position or appearance of the display virtual object. In some examples, when a user interacts with a display virtual object, the display may indicate that an interaction has occurred by providing a feedback. In the example of FIG. 4B, display virtual object 402 with which the user interacted may blink. In another example, a sound may be displayed such as, for example, a clicking sound when a button is pushed. In another example, the color of the display virtual object may change, for example, the color on a sliding bar may fade from one color to another as the user slides it from one side to the other.

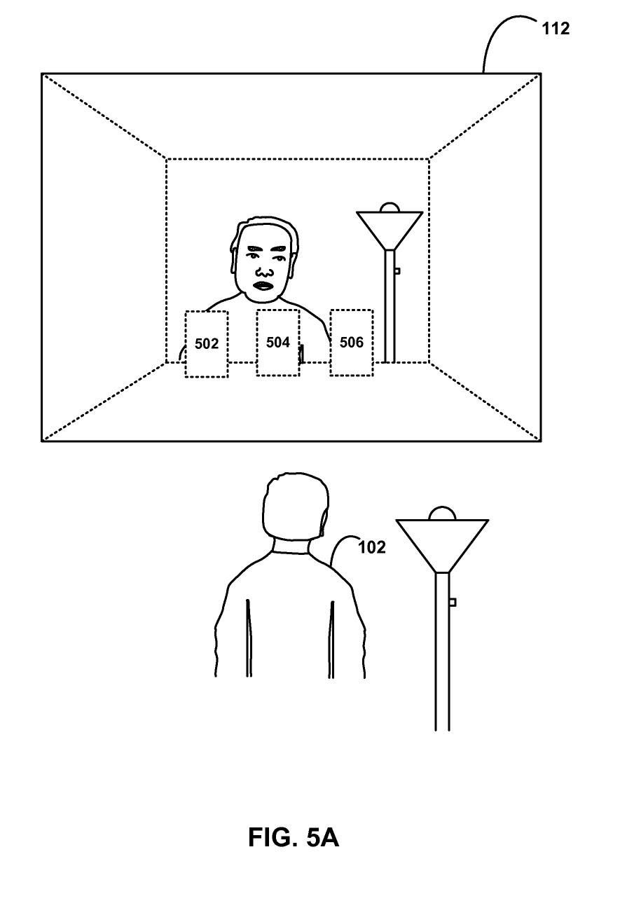

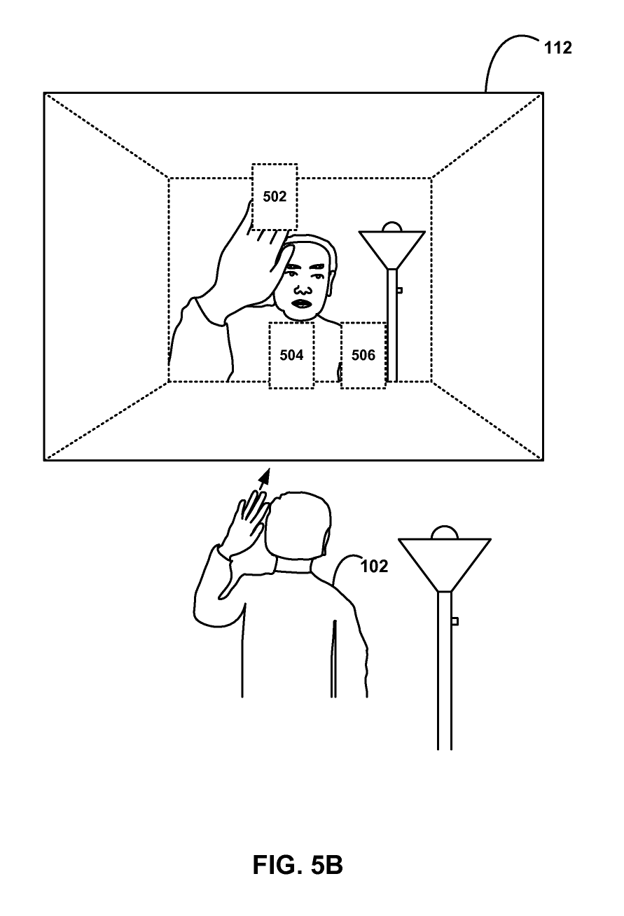

FIGS. 5 A-5B are other exemplary screen shots of a gesture-based user interface system display in accordance with this disclosure. In the illustrated example, a user 102 may stand or sit in a location within the field of view of the media-capturing device 202. The display 112 may show the virtual environment and display virtual objects (illustrated with dotted lines). Display virtual object 502, 504, and 506 may be objects with which the user may interact using gestures. When the system is first initiated, the user may have not yet interacted with the virtual environment or any display virtual objects. The image of the user and the real environment surrounding the user within the viewing field of media-capturing device 202 may be displayed on display 112, as illustrated in FIG. 5A. The image of the user and the real environment may be a mirror image of the user.

The user may then start interacting with the virtual environment by gesturing with his/her hands to drag one of the display virtual objects to another part of the screen, as illustrated in FIG. 5B. As the user gestures, using his/her left hand in this example, media-capturing device 204 may capture the user's image and gestures. Processor 205 may process the captured images, and send updated information to user interface unit 210, which may process the date from processor 205 with the display data stored in UI design information 208. The display data is then buffered to display device 112 for display. Display 112 then displays the image of the user and the recognized hand gesture is translated to an interaction with the appropriate display virtual object, in this example, object 502. As illustrated, the gesture of the user's hand is a dragging gesture, in the direction indicated by the arrow, and causes the display virtual object 502 to move accordingly. In one example, object 502 may appear farther away from the user than objects 504 and 506 in the virtual environment. In this example, the user may reach farther to interact with object 502 than if he/she wished to interact with objects 504 or 506.

The techniques described in this disclosure may be applicable in a variety of applications. In one example, this disclosure may be useful in a hand gesture-based gaming system, where a user may use hand gestures to interact with objects of a game. In another example, the disclosure may be used in teleconferencing applications. In yet another example, the disclosure may be useful in displaying demonstrations such as, for example, a product demo where a user may interact with a product displayed in the virtual world to show customers how the product may be used, without having to use an actual product.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), graphics processor unit (GPU), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause one or more programmable processors, or other processors, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various aspects and examples have been described. However, modifications can be made to the structure or techniques of this disclosure without departing from the scope of the following claims.

1. A system comprising:
a display device that presents an image of one or more display objects on a display screen;
at least one image-capturing device that obtains an image of a user;
a processor that recognizes a user gesture with respect to at least one of the display objects based on the image of the user; and
a processor that defines an interaction with the one or more display objects based on the recognized user gesture;
wherein the display device presents a 3-dimensional image on the display screen that combines the image of the one or more display objects and a mirror image of the user with an indication of the interaction.

2. The system of claim 1, wherein the at least one image-capturing device comprises at least one video-recording device.

3. The system of claim 1, wherein the at least one image-capturing device comprises a sensing device capable of obtaining information used to detect motion.

4. The system of claim 1, wherein the at least one image-capturing device comprises two or more image-capturing devices, the system further comprising a processor that determines location and depth associated with the user based on two or more images captured by the two or more image-capturing devices.

5. The system of claim 1, wherein the display device comprises a visual display and a speaker.

6. The system of claim 1, wherein the indication comprises a visual feedback affecting the appearance of the one or more display objects.

7. The system of claim 1, wherein the indication comprises an audio feedback.

8. A method comprising:
presenting an image of one or more display objects on a display screen;
obtaining an image of a user;
recognizing a user gesture with respect to at least one of the display objects based on the image of the user;
defining an interaction with the one or more display objects based on the recognized user gesture; and
presenting a 3-dimensional image on the display screen that combines the image of the one or more display objects and a mirror image of the user with an indication of the interaction.

9. The method of claim 8, wherein the image of the user is obtained using at least one image-capturing device.

10. The method of claim 9, wherein the at least one image-capturing device comprises at least one video-recording device.

11. The method of claim 9, wherein the at least one image-capturing device comprises a sensing device capable of obtaining information used to detect motion.

12. The method of claim 9, wherein the at least one image-capturing device comprises two or more image-capturing devices, the method further comprising determining location and depth associated with the user based on two or more images captured by the two or more image-capturing devices.

13. The method of claim 8, wherein the display comprises a visual display and a speaker.

14. The method of claim 8, wherein the indication comprises a visual feedback affecting the appearance of the one or more display objects.

15. The method of claim 8, wherein the indication comprises an audio feedback.

16. A computer-readable medium comprising instructions for causing a programmable processor to:
present an image of one or more display objects on a display screen;
obtain an image of a user;
recognize a user gesture with respect to at least one of the display objects based on the image of the user;
define an interaction with the one or more display objects based on the recognized user gesture; and
present a 3-dimensional image on the display screen that combines the image of the one or more display objects and a mirror image of the user with an indication of the interaction.

17. The computer-readable medium of claim 16, wherein the image of the user is obtained using at least one image-capturing device.

18. The computer-readable medium of claim 17, wherein the at least one image-capturing device comprises at least one video-recording device.

19. The computer-readable medium of claim 17, wherein the at least one image-capturing device comprises a sensing device capable of obtaining information used to detect motion.

20. The computer-readable medium of claim 17, wherein the at least one image-capturing device comprises two or more image-capturing devices, further comprising instructions that cause a processor to determine location and depth associated with the user based on two or more images captured by the two or more image-capturing devices.

21. The computer-readable medium of claim 16, wherein the display comprises a visual display and a speaker.

22. The computer-readable medium of claim 16, wherein the indication comprises a visual feedback affecting the appearance of the one or more display objects.

23. The computer-readable medium of claim 16, wherein the indication comprises an audio feedback.

24. A system comprising:
means for presenting an image of one or more display objects on a display screen;
means for obtaining an image of a user;
means for recognizing a user gesture with respect to at least one of the display objects based on the image of the user;
means for defining an interaction with the one or more display objects based on the recognized user gesture; and
means for presenting a 3-dimensional image on the display screen that combines the image of the one or more display objects and a mirror image of the user with an indication of the interaction.

25. The system of claim 24, wherein the means for obtaining comprise at least one image-capturing device.

26. The system of claim 25, wherein the at least one image-capturing device comprises at least one video-recording device.

27. The system of claim 25, wherein the at least one image-capturing device comprises a sensing device capable of obtaining information used to detect motion.

28. The system of claim 25, wherein the at least one image-capturing device comprises two or more image-capturing devices, the system further comprising means for determining location and depth associated with the user based on two or more images captured by the two or more image-capturing devices.

29. The system of claim 24, wherein the means for displaying comprises a visual display and a speaker.

30. The system of claim 24, wherein the indication comprises a visual feedback affecting the appearance of the one or more display objects.

31. The system of claim 24, wherein the indication comprises an audio feedback.
